(19) United States
(12) Patent Application Publication
(10) Pub. No.: US 2009/0226174 A1
(43) Pub. Date: Sep. 10, 2009

(54) Prediction of DWDM optical subnetwork degradation

(76) Inventors: Anamaria Csupor, Roselle Park, NJ (US); Clarence D. Paul, Old Bridge, NJ (US); James J. Robinson, Lebanon, NJ (US); Charles Schneider, Toms River, NJ (US); Mihail Vasilescu, Middletown, NJ (US)

Correspondence Address: AT & T LEGAL DEPARTMENT - Canavan, ATTN: PATENT DOCKETING, ROOM 2A-207, ONE AT & T WAY, BEDMINSTER, NJ, 07921, US

(21) Appl. No.: 12/074,540

(22) Filed: Mar. 4, 2008

(51) Int. Cl. H04J 14/02

(52) U.S. Cl. 398/89

(57) ABSTRACT

A system and method is disclosed that parses WDM subnetworks and collects TL1 Performance Monitoring (PM) parameter data from subnetwork network elements (NEs) and applies a set of comparisons to discover under-performing equipment according to predetermined operating thresholds. The comparisons examine NE pump laser baseline values, deviations, efficiency, tilt error, span loss and calculated expected optical power.

### BACKGROUND OF THE INVENTION

The invention relates generally to network communications. More specifically, the invention relates to a system and method for detecting degrading optical network elements in a subnetwork.

Today, a Transport Network Maintenance Center (TNMC) does not know when a large optical facility employing optical carrier lines conveying thousands of network layer 3 (Internet layer) customers begins to degrade. It may be after a month when the degradation becomes an actual component failure at an optical level, and the Synchronous Optical Networking/Synchronous Digital Hierarchy (SONET/SDH) transport protocol switches on ring or equipment protection. Until an actual component failure, upper applications at Internet Protocol (IP), Asynchronous Transfer Mode (ATM) and Frame Relay (FR) experience Performance Monitoring (PM) parameter faults.

Prior to an actual component failure, the optical facility begins to degrade without alarms, but with serious impact to the layers above. For example, an IP network that is being transported on the optical facility may exhibit large packet losses. To locate an optical facility that is degrading is not difficult, but finding where the degradation is manifesting itself at the optical level is a complex and difficult task.

What is desired is a system and method that detects the onset of optical component degradation which improves Mean Time To Repair (MTTR). By having the degrading component location data incorporated in a maintenance ticket or report, operations personnel can quickly remedy the subnetwork optical degradation by replacing the component predicted to fail rather than spending hours trouble shooting the subnetwork after a hard failure.

### SUMMARY OF THE INVENTION

The inventors have discovered that it would be desirable to have a system and method that detects degrading optical subnetwork components. Degradation experienced at the network layer 1 (physical) can produce different degrees of failures in network layers 2 (data link layer) and 3 (network layer) protocols. Embodiments collect PM parameter data from Wavelength Division Multiplexing (WDM) Network Elements (NEs) such as Alcatel-Lucent 400 G Dense Wavelength Division Multiplexing (DWDM) NEs via a set of Transaction Language 1 (TL1) messages. The messages may include Retrieve PM Optical Line, Retrieve Tilt Data, Retrieve PM Optical Channel (where each optical line has a set of optical channels), Retrieve Map Ring (subnetwork topology layout), and others. A plurality of PM parameter thresholds are employed to identify NE degradation.

Once a DWM multiplexer/demultiplexer or Optical Amplifier (OA) is identified as degrading (operating outside of their predetermined thresholds), a request for issuing a maintenance ticket is generated or daily/weekly reports issued identifying the applicable metrics.

One aspect of the invention provides a method for detecting degrading subnetwork optical Network Elements (NEs). Methods according to this aspect of the invention include setting predetermined thresholds for predetermined subnetwork NE performance parameters and subnetwork performance calculations, acquiring predetermined Performance Monitoring (PM) parameter data samples from subnetwork NEs corresponding to the predetermined subnetwork NE performance parameters and subnetwork performance calculations, deriving the predetermined subnetwork performance calculations using the predetermined PM parameter data samples, comparing the predetermined PM parameter data samples with the corresponding predetermined thresholds for the predetermined subnetwork NE performance parameters and subnetwork performance calculations, if any of the predetermined subnetwork NE performance parameters and subnetwork performance calculations are outside of their predetermined thresholds, saving the error between the predetermined subnetwork NE performance parameter(s) and/or subnetwork performance calculation(s) and their predetermined thresholds and storing the error(s), after a subsequent sample of the predetermined PM parameter data, if any of the predetermined subnetwork NE performance parameters and subnetwork performance calculations are outside of their predetermined thresholds, saving an error corresponding to the error between the subsequent predetermined subnetwork NE performance parameter(s) and/or subnetwork performance calculation(s) and their predetermined thresholds, comparing a previous error with a subsequent error, if the comparison between a subsequent error and a previous error shows an error increase, issuing a maintenance ticket for the corresponding NE; and if the comparison between a subsequent error and a previous error does not show an error increase, accumulating a series of errors based on subsequent samples of the predetermined PM parameter data for the predetermined subnetwork NE performance parameter(s) and subnetwork performance calculation(s) for a predetermined accumulation time and issuing a report.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary optical subnetwork.

FIG. 2 is an exemplary component degradation identification system.

FIG. 3 is an exemplary component degradation identification method.

FIG. 4 is an exemplary optical amplifier (OA) output power spectrum affected by gain tilt and ripple.

### DETAILED DESCRIPTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having,” and variations thereof herein is meant to encompass the items listed thereafter and equivalents thereof as well as additional items.

The terms “connected” and “coupled” are used broadly and encompass both direct and indirect connecting and coupling. Further, “connected” and “coupled” are not restricted to physical or mechanical connections or couplings.

It should be noted that the invention is not limited to any particular software language or any particular WDM/DWDM technology described or that is implied in the figures. One of ordinary skill in the art will understand that a variety of alternative software languages may be used for implementation of the invention.

Embodiments of the invention provide methods, systems, and a computer-usable medium storing computer-readable instructions for detecting degrading optical subnetwork components. The invention is a modular framework and is deployed as software as an application program tangibly embodied on a program storage device. The application code for execution can reside on a plurality of different types of computer readable media known to those skilled in the art.

Wavelength Division Multiplexing (WDM) modulates multiple data channels into optical signals that have different frequencies and then multiplexes these signals into a single stream of light that is sent over a fiber optic cable. Each optical signal has its own frequency, such that many separate data streams can be transmitted simultaneously over the fiber. In addition, each data stream can employ its own transmission format or protocol. By employing WDM, SONET, ATM, Transmission Control Protocol/IP (TCP/IP), and other transmissions can be combined and sent simultaneously over a single fiber. At the other end, a multiplexer demultiplexes the signals and distributes them to their various data channels

WDM systems are popular with long-distance carriers (inter-exchange carriers, or IXCs) because they allow them to expand the capacity of the network without laying more fiber. By using WDM and optical amplifiers (OAs), they can accommodate several generations of technology development in their optical infrastructure without having to overhaul the backbone network. This is often performed using optical-to-electrical-to-optical (OEO) translation at the edges of a transport subnetwork, thus permitting interoperation with existing equipment with optical interfaces.

WDM includes both coarse (CWDM) and dense (DWDM) WDM systems that support OC-192 SONET signals that in turn support thin-SONET framed 10 Gigabit Ethernet. An advantage of WDM transmission is bit-rate transparency as conferred by the purely optical functions, such as optical multiplexers (OMUXs) and demultipexers (ODMUXs), optical line amplifiers (OAs), and optical repeaters for long-link distances. In principle, the link includes no bit-rate limiting elements that would require a change of optical line components to achieve a higher bit-rate.

The WDM interfaces are typically managed using a TL1 protocol. TL1 is a traditional telecom language for managing and reconfiguring SONET NEs. TL1 or other command languages used by SONET NEs may be carried by other management protocols such as SNMP, CORBA and XML.

Optical NEs have a large set of standards for PM parameter data. The PM parameters not only allow for monitoring the status (health) of individual NEs, but for the isolation and identification of most network defects or outages. Higher-layer management software allows for the proper filtering and troubleshooting of network-wide PM so that defects and outages can be quickly identified and responded to.

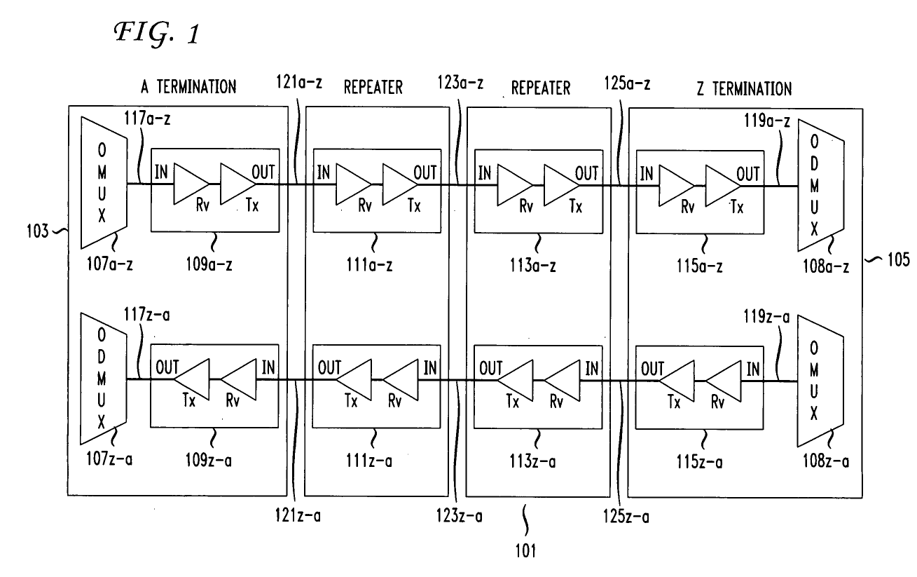

An exemplary DWDM optical subnetwork may be defined as having a source node A terminating NE, a destination node Z terminating NE, and one or more repeater(s) in-between. FIG. 1 shows an exemplary optical subnetwork 101. The subnetwork 101 topology is bidirectional comprising two fibers. The invention may be applied to hubbed-rings, multi-hubbed rings, any-to-any rings, meshed rings, and variations of linear configurations, and other types of optical carriers.

The subnetwork 101 includes a working traffic line 103, a protection traffic line 105, OMUXs 107a-z, 107z-a (collectively 107), ODMUXs 108a-z, 108z-a (collectively 108) and repeaters 109a-z, 109z-a, 111a-z, 111z-a, 113a-z, 113z-a, 115a-z, 115z-a. The OMUXs 107a-z, 107z-a are coupled to a first repeater 109a-z, 115z-a for output optical amplification over optical fiber 117a-z, 119z-a. The outputs of the first repeaters 109a-z, 115z-a are output over fiber 121a-z, 125z-a. One or more repeaters 111a-z, 113a-z, 113z-a, 111z-a may be required between the OMUXs 107a-z, 107z-a and ODMUXs 108a-z, 108z-a, interrupting the fiber run 121a-z, 123a-z, 125a-z, 125z-a, 123z-a, 121z-a to maintain signal level due to optical attenuation over distance. The last fiber segment 125a-z, 121z-a is coupled to a last repeater 115a-z, 109z-a for amplification and coupled over fiber 119a-z, 117z-a to the ODMUXs 108a-z, 108z-a. Each subnetwork 101 may be coupled to other subnetworks (not shown) completing a path between a customer's SONET/SDH connections (not shown).

The terminal OMUXs 107 typically contain one wavelength converting transponder for each wavelength signal the subnetwork will carry. The wavelength converting transponders receive an input optical signal, for example from a client-layer SONET/SDH, convert that signal into the electrical domain and retransmit the signal using a laser. The OMUXs 107 also contain an optical multiplexer, which takes the optical signals and places them onto a single fiber. The OMUXs 107 may support a local Erbium Doped Fiber Amplifier (EDFA) for amplifying the multi-wavelength optical signal.

The intermediate optical repeaters 109, 111, 113, 115, or Optical Add/Drop Multiplexers (OADMs), provide remote amplification that amplifies the multi-wavelength signal that may have traversed up to 140 km or more. Each repeater 109, 111, 113, 115 may include receive (Rv) and transmit (Tx) OAs, and may also be configured as a reconfigurable OADM. The Rv and Tx OAs typically are doped fiber amplifiers that use a doped optical fiber as a gain medium to amplify an optical signal. The signal to be amplified and a pump laser are multiplexed into the doped fiber, and the signal is amplified through interaction with the doping ions. Optical diagnostics and telemetry are often extracted or inserted at a repeater to allow for localization of any fiber breaks and signal impairments and degradations.

The terminal ODMUXs 108 separate the multi-wavelength signal back into individual signals and outputs them on separate fibers for client-layer systems (SONET/SDH). The functionality of an output transponder has been integrated into that of input transponder such that most commercial systems have transponders that support bi-directional interfaces on both their network-facing side (internal) and client-facing side (external).

An Optical Supervisory Channel (OSC) is an additional wavelength outside the EDFA amplification band. The OSC carries information about the multi-wavelength optical signal as well as remote conditions at the optical terminal or EDFA sites. It is also normally used for remote software upgrades and user network Performance Monitoring (PM) parameter information. It is a multi-wavelength analog to SONET's Data Communication Channel (DCC) supervisory channel. The OMUXs 107, repeaters 109, 111, 113, 115 and ODMUXs 108 employ an OSC. The OSC is always terminated at intermediate amplifier sites where it receives local information before retransmission.

SONET network management for SONET NEs has a number of management interfaces. These are an electrical interface and a craft interface. The electrical interface sends TL1 commands from a local management network physically housed in an office where a SONET NE is located to any location for monitoring. The TL1 commands are used for local management of that NE and remote management of other SONET NEs. The craft interface are for local technicians who can access a SONET NE on a port and issue commands through a dumb terminal or terminal emulation program running on a laptop.

SONET/SDH have dedicated DCCs within their section and line overhead for management traffic. There are three modes used for management, an IP-only stack using Point-to-Point Protocol (PPP) as a data-link, an Open Systems Interconnection (OSI)-only stack, using Link Access Procedures, D-channel (LAP-D) as a data-link, and a dual (IP+OSI) stack using PPP or LAP-D with tunneling functions to communicate between stacks.

Embodiments of the system and method parse WDM subnetworks and collect PM parameter data from their NEs. Methods are applied to the PM parameter data to discover under-performing NEs per expected operating thresholds. The methods examine 1) repeater Rv and Tx OA pump laser power baseline dB values, 2) OA pump laser power baseline dB deviations, 3) OA pump laser tilt values, 4) calculated subnetwork span losses, 5) OA pump laser efficiencies, and 6) Calculated Expected Optical Powers (CEOPs). A table of subnetwork performance status is generated and a report generator application provides the optical Transport Network Maintenance Center (TNMC) with a report of degraded equipment per subnetwork.

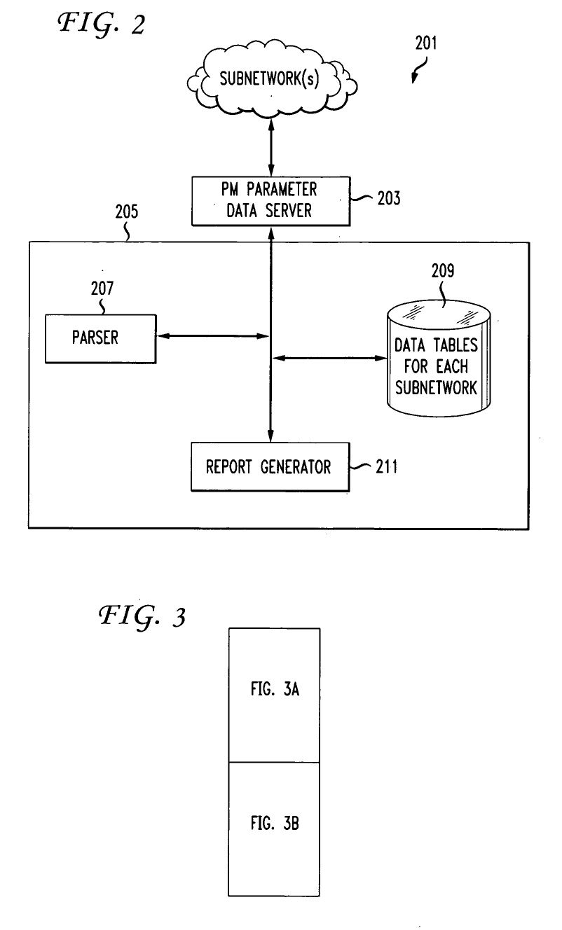

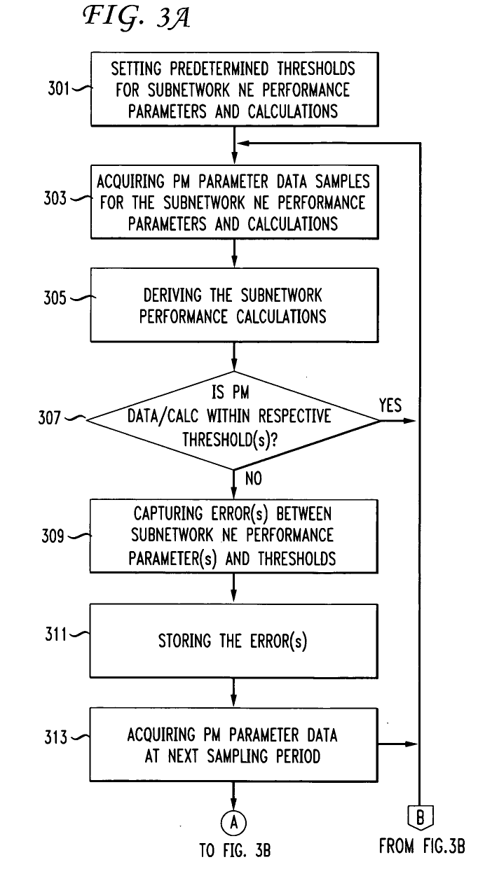

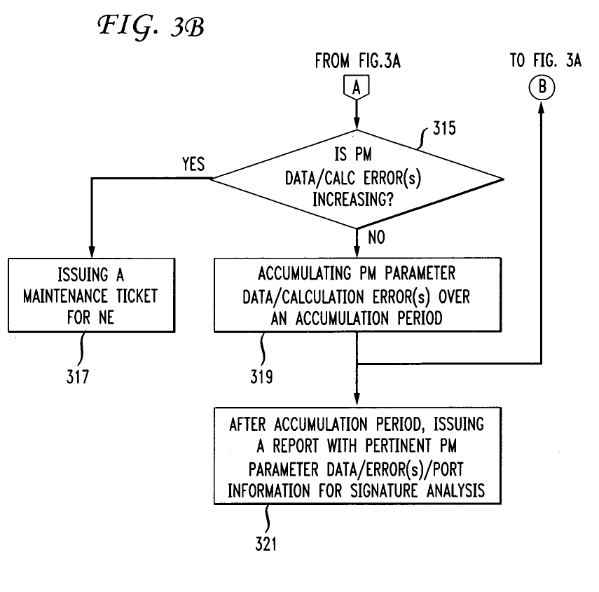

FIG. 2 shows the component degradation identification system 201 and FIG. 3 shows the method. A DWDM subnetwork is coupled to an input of a PM parameter data server 203 which sends TL1 commands and accumulates PM parameter data from subnetwork NEs. A PM data server output is coupled to a prediction framework 205 that includes a parser 207, data tables for each subnetwork monitored 209 and a report generator 211.

The PM data server 203 monitors the TL1 messages and OSC channels for each subnetwork. The data server 203 retrieves map ring, PM parameter data, tilt data, PM optical channel data and other data types and assembles a database that trends the acquired data for each subnetwork monitored. The parser 207 applies predetermined threshold comparisons to predetermined accumulated subnetwork NE PM parameter data. The results are stored in data tables 209 for each subnetwork.

Predetermined thresholds are set for predetermined subnetwork NE PM parameters and subnetwork performance calculations (step 301). The predetermined thresholds are defined for PM parameters corresponding to each Rv OA pump laser baseline (for example, <−15 dB) and Tx OA pump laser baseline (for example, <+11 dB), for each Rv OA and Tx OA pump laser baseline deviation (for example, −6 dB to +2 dB), for each Rv OA and Tx OA pump laser tilt value (for example, ±2 dB), for each Rv OA and Tx OA pump laser efficiency (for example, <0.89), and for calculating subnetwork span loss and CEOP. Each threshold is determined based on input received from the component manufacturer and empirical operational experience.

Predetermined NE PM parameter data samples from each subnetwork NE (OMUX OAs, repeater OAs and ODMUX OAs) are acquired corresponding to the predetermined thresholds and performance calculations. The data is stored and trend by the PM data server 203 (step 303). For example, PM parameter data samples for Rv and Tx OA pump laser baseline values 111a-z. Subnetwork PM parameter data may be acquired every 24 hours by the PM data server 203 and assembled as a Historic PM Parameter Database (HPDB) 209. The PM parameter data is typically acquired, or counted, in 15 minute buckets, totaling 96 buckets per 24 hour period. Subnetwork performance calculations for span loss and CEOP are derived using the required predetermined PM parameter data (step 305).

The following TL1 commands are issued by the PM data server 203 and acquire the PM parameter data from subnetwork NEs. The TL1 command “Retrieve Map Ring” provides subnetwork layout connectivity,

A Termination® Repeater(s)® Z termination, and (1)

Z Termination® Repeater(s)® A termination. (2)

“Retrieve PM Optical Line” provides the current PM parameter value and the PM parameter baseline value with date and time attached for Rv and Tx OA pump laser powers in dBm (dBmW) and efficiency. “Retrieve Optical Line Provisioned Parameters” provides Rv and Tx OA pump laser tilt values, and “Retrieve PM Optical Channel” provides the number of OC-48 and OC-192 provisioned optical channels distributed per optical line for CEOP calculation.

The predetermined PM parameter data is compared with their corresponding predetermined thresholds and the derived subnetwork performance calculations are compared with their corresponding subnetwork performance calculation thresholds (step 307). Each Rv and Tx OA pump laser power is trend and compared against their respective predetermined thresholds (for example, Rv<−x dB; Tx<+y dB for repeater 111a-z). Each Rv and Tx OA pump laser efficiency is trend and compared against their predetermined thresholds. A baseline deviation is applied to each Rv and Tx OA pump laser power. The acquired pump laser tilt value for each Rv and Tx OA is compared against their respective predetermined thresholds (±z dB). A subnetwork span loss is calculated and compared with a predetermined threshold. A subnetwork CEOP is calculated and compared with a predetermined threshold. Six threshold comparisons are listed, however, more or less may be observed and compared with their respective predetermined thresholds. PM parameter data is used by the invention to trend and detect degrading NEs. Baseline values are established and deviations from the baseline are monitored.

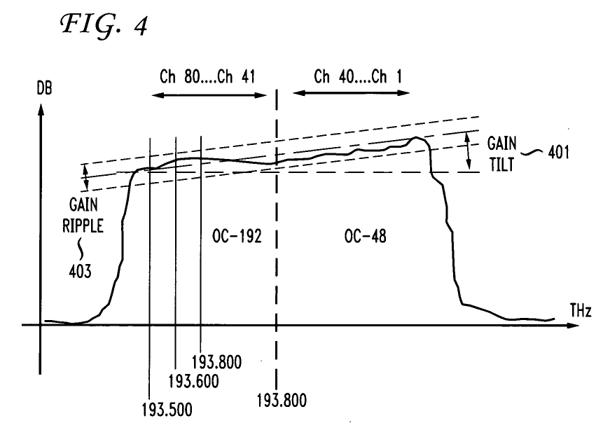

A critical parameter to assure optical spectrum equalization throughout a subnetwork is the gain flatness of repeater Rv and Tx OA EDFA pump lasers. Gain tilt and ripple are factors in the power equalization of OAs. FIG. 4 shows a plot of an exemplary OA Tx output power spectrum and how it is affected by gain tilt 401 and gain ripple 403.

Gain tilt 401 is systematic and depends on the gain setpoint Gₛₜₚₜ of an OA pump laser, which is a mathematical function F(Gₛₜₚₜ) that relates to the internal amplifier design. Gain tilt is the only contribution to the power spectrum disequalization that can be compensated for. Gain ripple 503 is random and depends on the spectral shape of the amplifier optical components. An optical spectrum analyzer (OSA) function accomplished by an optical monitoring component augmented within DWDM systems is used to acquire the spectrum characteristics of each OA. The OSA function shows the peak-to-peak difference between the maximum and minimum power levels, and takes into account the contributions of both gain tilt 401 and gain ripple 403. For example, gain tilt 401 measurements that are ±2 dB outside of baseline may indicate an OA is operating out-of-range. It is based on the PM parameter data measured in dBm (dBmW) at the source node A and destination node Z.

Span loss compares far-end optical service channel (OSC) power with near-end OSC power. For example, from repeater 115a-z Tx OA with the near-end optical amplifier power from repeater 109a-z Rv OA. The measurements are trend for a period of time, for example, 24 hours, and a daily average is taken for the far-end and near-end powers. Span loss is calculated as

span loss=daily average transmit−daily average receive. (3)

A Span Loss Out-of-Range condition is raised when the measured span loss is greater than its threshold, the maximum expected span loss. It is also raised when the measured span loss is less than its threshold, the minimum expected span loss and the difference between the minimum and maximum span loss values is greater than 1 dB.

OA pump laser efficiency is related to reliability, and is a critical active component. Pump lasers tend not to fail suddenly, but degrade slowly and predictably over time. Because pump lasers are an EDFA component, pump requirements are dictated by amplifier designs that support higher-bandwidth system architectures. Increased channel count necessitates proportionately higher total pump laser power.

Baseline values are based on field experience on precedent failures mapped to historic PM data, and input received from the equipment manufactures. Baseline benchmarks are set at the time of system installation and as determined by the engineered route design. NEs allow for provisionable parameters (baseline values) to be set during installation and modified subsequently when a repair is performed which affects either the fiber characteristic on the route (i.e. Planned Cable Intrusion (PCI) or fiber cut) or when an OA is replaced after failure. Embodiments enable a user (analyst) to determine if a baseline has been mal-adjusted (i.e. to quiet annoying threshold alerts).

The CEOP for a particular NE is calculated,

CEOP=10 log₁₀[N₁₉₂′4.47+N₄₈′2.24], (4)

where N₁₉₂ is the number of OC-192 channels in use and N₄₈ is the number of OC-48 channels in use. CEOP is a dimensionless value. The values 4.47 and 2.24 are coefficients defined by a manufacturer, for example, Lucent. The above coefficients are specific to Lucent 400 G DWDM.

An optical power measurement is not required for calculating CEOP. From the TL1 command “Retrieve PM Optical Channel” the number of provisioned OC-48 and OC-192 in the DWDM subnetwork is obtained and used in (4) per DWDM subnetwork. 9495 is the shortening of the center frequency wavelength when given in THz. 194.950 THz is optical channel (Ochan) 9495.

FIG. 4 shows a generic spectrum. The spectrum provides the number of OC-48 and OC-192 provisioned channels on a specific subnetwork. The TL1 command “Retrieve PM Optical Channel” provides the frequency for all active provisioned channels on the line. The TL1 command indicates the frequency, not the channel size (OC-48/OC-192). Provisioned OC-192 channels are in the spectrum less than 193.800 THz and provisioned OC-48 channels are in the spectrum greater than 193.800 THz.

(4) allows for the calculation of what each Rv and Tx OA optimal optical output level should be. Based on the number of channels and type, a weighting factor (4.47 for OC-192 and 2.24 for OC-48) may be used to determine what a given OA's output power should be. That value, along with other comparative data, may be used by a user such as a technical support analyst to determine if the amplifier's actual measured output is within its threshold or not.

If any of the predetermined subnetwork NE performance parameters and subnetwork performance calculations are outside of their predetermined thresholds, an error is calculated between the predetermined subnetwork NE performance parameter(s) and/or subnetwork performance calculation(s) and their predetermined thresholds (step 309). The error is captured and stored for trending for that NE or subnetwork calculation (step 311). The above described comparisons are applied to their PM parameter data. If a PM parameter is within a respective threshold, the method continues with another PM parameter data sample comparison.

After a subsequent PM parameter data sampling (step 313), if a subnetwork NE or calculation comparison is not within its threshold (step 307) and when the subsequent error is compared with a previous error and is increasing (step 315), meaning that the NE or subnetwork calculation is degrading, an error corresponding to the error between the subsequent PM parameter data sample and its predetermined threshold is captured and stored, and a maintenance ticket is issued for that comparison with its TID/AID and other pertinent information (step 317).

If after a subsequent PM parameter data sampling period, a subnetwork NE or calculation comparison is not within its threshold (step 307) and when the subsequent error is compared with a previous error is not increasing (step 315), meaning that the NE or subnetwork calculation, while under-performing, requires further examination prior to replacement. Subsequent errors are accumulated over a predetermined accumulation period (step 319) and trend.

The method trends the performance errors to examine how long a subnetwork NE or subnetwork calculation comparison is outside of its threshold but is not worsening over time or remaining the same. Most degradation observed by the above comparisons will not show as a sudden subnetwork perturbation, but a gradual increase if degrading. Data tables are maintained for each trend subnetwork NE or subnetwork calculation comparison.

If after performance error trending, an upward trend is not detected for the subnetwork NE or subnetwork calculation, a report may be issued showing the tabulated errors for that subnetwork PM parameter or subnetwork calculation in conjunction with other data pertaining to that subnetwork for further examination by a network analyst (step 321). The subnetwork status report can be generated 211 per period of time (e.g. weekly) providing subnetwork identification, NE TID (NE identification), direction (“A to Z” or “Z to A”), line channel, type (e.g. transmitter or receiver), port identification, baseline value, current daily values, minimum 15 minute bucket value, maximum 15 minute bucket value, fed From TID NE ID, daily average of transmitter, span loss (3), tilt error, pump efficiency and CEOP.

All six monitored parameters may act independently of each other, or their results may be combined to derive a signature for predicting a specific failing NE. For example, a combination of parameters such as a repeater Rv OA and Tx OA pump lasers being out-of-threshold in combination with their tilt errors being greater than ±2 dB could provide an alert that that specific repeater needs replacement even though a hard failure may be months away. As a measured PM parameter reaches its threshold, a signature of an NE failure is derived. The signature signals a possible degradation to services running on the protocols above, for example, Ethernet, IP and Applications.

One or more embodiments of the present invention have been described. Nevertheless, it will be understood that various modifications may be made without departing from the spirit and scope of the invention. Accordingly, other embodiments are within the scope of the following claims.

What is claimed is:

1. A method for detecting degrading subnetwork optical Network Elements (NEs) comprising:
setting predetermined thresholds for predetermined subnetwork NE performance parameters and subnetwork performance calculations;
acquiring predetermined Performance Monitoring (PM) parameter data samples from subnetwork NEs corresponding to the predetermined subnetwork NE performance parameters and subnetwork performance calculations;
deriving the predetermined subnetwork performance calculations using the predetermined PM parameter data samples;
comparing the predetermined PM parameter data samples with the corresponding predetermined thresholds for the predetermined subnetwork NE performance parameters and subnetwork performance calculations;
if any of the predetermined subnetwork NE performance parameters and subnetwork performance calculations are outside of their predetermined thresholds, saving the error between the predetermined subnetwork NE performance parameter(s) and/or subnetwork performance calculation(s) and their predetermined thresholds and storing the error(s);
after a subsequent sample of the predetermined PM parameter data, if any of the predetermined subnetwork NE performance parameters and subnetwork performance calculations are outside of their predetermined thresholds, saving an error corresponding to the error between the subsequent predetermined subnetwork NE performance parameter(s) and/or subnetwork performance calculation(s) and their predetermined thresholds;
comparing a previous error with a subsequent error;
if the comparison between a subsequent error and a previous error shows an error increase, issuing a maintenance ticket for the corresponding NE; and
if the comparison between a subsequent error and a previous error does not show an error increase, accumulating a series of errors based on subsequent samples of the predetermined PM parameter data for the predetermined subnetwork NE performance parameter(s) and subnetwork performance calculation(s) for a predetermined accumulation time and issuing a report.

2. The method according to claim 1 wherein acquiring predetermined PM parameter data samples from subnetwork NEs corresponding to the predetermined subnetwork NE performance parameters and subnetwork performance calculations further comprises sending TL1 commands.

3. The method according to claim 2 wherein a TL1 command “Retrieve Map Ring” provides subnetwork layout connectivity.

4. The method according to claim 2 wherein a TL1 command “Retrieve PM Optical Line” provides Rv Optical Amplifier (OA) and Tx OA pump laser efficiency and power.

5. The method according to claim 2 wherein a TL1 command “Retrieve Optical Line Provisioned Parameters” provides OA pump laser tilt value.

6. The method according to claim 2 wherein a TL1 command “Retrieve PM Optical Channel” provides a count of the number of OC-48 and OC-192 provisioned optical channels distributed per optical line in a subnetwork.

7. The method according to claim 4 wherein setting predetermined thresholds for predetermined subnetwork NE performance parameters includes Rv OA pump laser power <−x dB and Tx OA pump laser power <+y dB.

8. The method according to claim 4 wherein setting predetermined thresholds for predetermined subnetwork NE performance parameters includes Rv and Tx OA pump laser efficiency.

9. The method according to claim 4 wherein setting predetermined thresholds for predetermined subnetwork NE performance parameters includes Rv and Tx OA pump laser power baseline deviation −a dB to +b dB.

10. The method according to claim 3 wherein setting predetermined thresholds for predetermined subnetwork performance calculations includes span loss.

11. The method according to claim 5 wherein setting predetermined thresholds for predetermined subnetwork NE performance parameters includes Rv and Tx OA pump laser tilt ±z dB.

12. The method according to claim 6 wherein setting predetermined thresholds for predetermined subnetwork performance calculations further comprises calculating a Calculated Expected Optical Power (CEOP).

13. The method according to claim 1 further comprising deriving a prediction signature for predicting the failure of a predetermined subnetwork NE based on the errors from its respective PM parameter data/threshold comparisons.

14. The method according to claim 13 wherein the prediction signature further comprises considering subnetwork layout information.

15. The method according to claim 13 wherein the prediction signature further comprises considering subnetwork direction.

16. The method according to claim 13 wherein the prediction signature further comprises a combination of all errors from the subnetwork NEs.

17. The method according to claim 1 wherein the report includes errors from its respective PM parameter data/threshold comparisons, subnetwork layout information, subnetwork direction and combination of all errors from the subnetwork NEs.

18. A system for detecting degrading subnetwork optical Network Elements (NEs) comprising:
means for setting predetermined thresholds for predetermined subnetwork NE performance parameters and subnetwork performance calculations;
means for acquiring predetermined Performance Monitoring (PM) parameter data samples from subnetwork NEs corresponding to the predetermined subnetwork NE performance parameters and subnetwork performance calculations;
means for deriving the predetermined subnetwork performance calculations using the predetermined PM parameter data samples;
means for comparing the predetermined PM parameter data samples with the corresponding predetermined thresholds for the predetermined subnetwork NE performance parameters and subnetwork performance calculations;
if any of the predetermined subnetwork NE performance parameters and subnetwork performance calculations are outside of their predetermined thresholds, means for saving the error between the predetermined subnetwork NE performance parameter(s) and/or subnetwork performance calculation(s) and their predetermined thresholds and means for storing the error(s);
after a subsequent sample of the predetermined PM parameter data, if any of the predetermined subnetwork NE performance parameters and subnetwork performance calculations are outside of their predetermined thresholds, means for saving an error corresponding to the error between the subsequent predetermined subnetwork NE performance parameter(s) and/or subnetwork performance calculation(s) and their predetermined thresholds;
means for comparing a previous error with a subsequent error;
if the comparison between a subsequent error and a previous error shows an error increase, means for issuing a maintenance ticket for the corresponding NE; and
if the comparison between a subsequent error and a previous error does not show an error increase, means for accumulating a series of errors based on subsequent samples of the predetermined PM parameter data for the predetermined subnetwork NE performance parameter(s) and subnetwork performance calculation(s) for a predetermined accumulation time and means for issuing a report.
